(19) United States
(12) Patent Application Publication
(10) Pub. No.: US 2022/0414550 A1
(43) Pub. Date: Dec. 29, 2022

(54) SYSTEM AND METHOD FOR OPTIMIZING A FLIGHT PATH USING A NEURAL NETWORK

(71) Applicant: Alternative Travel, LLC d/b/a TravelClubIQ, Cheyenne, WY (US)

(72) Inventor: Danielle Massell, Las Vegas, NV (US)

(21) Appl. No.: 17/528,684

(22) Filed: Nov. 17, 2021

Related U.S. Application Data
(60) Provisional application No. 63/215,420, filed on Jun. 26, 2021.

(51) Int. Cl. G06Q 10/02; G01C 21/20

(52) U.S. Cl. CPC G06Q 10/02; G01C 21/20

(57) ABSTRACT

The invention generally pertains to a method for identifying an optimal flight path for travel between a starting location and a destination location utilizing neural network layered with a series of algorithmic functions to align travel with personal wants/needs. Modeled loosely on the human brain, a neural net consists of thousands or even millions of simple processing nodes that are densely interconnected. When a neural net is being trained, all of its weights and thresholds are initially set to random values. Training data is fed to the bottom layer—the input layer—and it passes through the succeeding layers, getting multiplied and added together in complex ways, until it finally arrives, radically transformed, at the output layer. During training, the weights and thresholds are continually adjusted until training data with the same labels consistently yield similar outputs.

### FIELD OF THE INVENTION

Aspects of embodiments described herein apply to a unique implementation of travel software to facilitate the construction of an optimized flight path for a user selected beginning origination and end destination.

### BACKGROUND OF THE INVENTION

Communication networks are well known in the computer communications field. By definition, a network is a group of computers and associated devices that are connected by communications facilities or links. Networks may vary in size, from a local area network (“LAN”) consisting of a few computers or workstations and related devices; to a wide area network (“WAN”) which interconnects computers and LANs that are geographically dispersed; to a remote access service (“RAS”) which interconnects remote computers via temporary communication links. An internetwork, in turn, is the joining of multiple computer networks, both similar and dissimilar, by means of gateways or routers that facilitate data transfer and conversion from various networks. A well-known abbreviation for the term internetwork is “internet.” As currently understood, the capitalized term “Internet” refers to the collection of networks and routers that use the Internet Protocol (“IP”) along with higher level protocols such as the Transmission Control Protocol/Internet Protocol (“TCP/IP”) or the Uniform Datagram Packet/Internet Protocol (“UDP/IP”) to communicate with one another.

The Web is a vast collection of interconnected or “hypertext” documents in HyperText Markup Language (“HTML”) that are electronically served at “Web sites” throughout the Internet. The Web has quickly become a popular method of disseminating information due in large part to its simplicity and its ability to deliver information in a variety of formats. To make information available over the Web, a user typically composes a set of “Web pages” which are posted on a Web site by an Internet Service Provider (“ISP”). A Web site resides on a server connected to the Internet that has mass storage facilities for storing hypertext documents, a.k.a. “Web pages,” and that runs administrative software for handling requests for those stored hypertext documents. A hypertext document normally includes a number of hyperlinks, i.e., highlighted portions of text which link the document to another hypertext document possibly stored at a Web site elsewhere on the Internet. Each hyperlink is associated with a Uniform Resource Locator (“URL”) that provides the exact location of the linked document on a server connected to the Internet and describes the document. Thus, whenever a hypertext document is retrieved from any Web server, the document is retrieved from the Web.

A user is allowed to retrieve hypertext documents from the Web, i.e., a user is allowed to “surf the Web,” via a Web browser. A Web browser, such as GOOGLE® Chrome, MICROSOFT® Edge or APPLE® Safari, is a software program implemented by a Web client, i.e., the user's computer, cell phone or other client device, to provide a graphical user interface (“GUI”) to the Web. Upon request from the user via the Web browser, the Web client accesses and retrieves the desired hypertext document from the appropriate Web server using the URL for the document and a protocol known as HyperText Transfer Protocol (“HTTP”). HTTP is a higher-level protocol than TCP/IP and is designed specifically for the requirements of the Web. It is used on top of TCP/IP to transfer hypertext documents between servers and clients.

The present description relates to network-based, and Internet-based travel services, such as a travel service offering tickets for transportation to customers over the Internet. With such a service, a customer, using a computer connected to the travel service via the Internet, can purchase items from a dynamically changing inventory. Typically, a travel service cooperates with a centralized computer reservation system (“CRS”). A CRS is a system/service that communicates with travel agents' transportation providers or services for the purpose of providing up-to-date fare (price for the trip or combination of routs comprising a trip), schedule (date and time of arrival and departure of a trip or flight), rules (which fares are valid under which circumstances) and availability (capacity for a particular trip or flight to provide accommodation at a particular fare) in response to a query. This information is provided to the CRS by the transportation carriers, typically through third parties; however, a travel service can also cooperate with other databases, such as a local database reflecting specific relationships between carriers and the travel service, such as discount contracts or incentive programs. Accordingly, an Internet-based service can have access to many sources of carrier inventory and prices.

The business environment of a travel service is such that there are numerous ways of providing the same or a similar end product to the consumer at a variety of prices. Due to carrier-driven preferences, it may be cost effective to price similar inventory differently. For example, in the case of airline reservations, the number of ways that a consumer can travel from point A to point B is great when the number of airline carriers, different travel paths, hub locations and other particulars are considered. For this reason, the price of a particular generic segment from point A to point B may vary considerably across time, airline carriers, and the like. Further, compounding price variations are price sensitivities, which can reflect, e.g., an increase in demand for tickets reserved proximate to departure time. Additionally, incentive and discount programs negotiated with individual carriers can further affect the price offered by a travel service. Also, certain classes of inventory may have associated high or low demands, or high or low volume sales.

In addition, there are numerous consumer driven preferences which can affect pricing as well. Some consumers will value individual characteristics of a given item of inventory differently. For example, in the case of airline tickets, a consumer may not value when the flight (flying from one place to the next) takes place whereas another consumer may value a particular carrier over all others. These preferences can be factored into flights offered when the consumer specifies the preference. For these reasons and others, there are numerous factors that can affect the value of the same or similar end product.

Furthermore, in a conventional Internet-based travel service, a consumer enters very specific information concerning desired supplier inventory, and the internet-based travel service queries a CRS for inventory that matches that specific query. The CRS performs a search of its database to find matches for the query and returns a result set to the Internet-based travel service for viewing by the consumer. However, a traditional CRS search in response to a query is limited.

One limitation results from the fact that there are numerous ways of providing the same end product to the consumer. For example, there are an incalculable number of ways to travel from point A to point B when different suppliers, travel routes, and other particulars are considered. Thus, for economic reasons, the CRS typically spends a fixed amount of time searching its database for information fulfilling the query. Consequently, when a CRS returns results to a travel service in response to a query, the CRS returns very limited and usually non-optimized results for that particular query, simply because not every permutation or combination of possible inventory elements can be searched. As a result, some inventory that matches the query does not appear in the result set returned by the CRS. Thus, it would be beneficial to provide a service capable of a more exhaustive inquiry without incurring substantial or prohibitive increases in CRS search time and computing power. The provision of such a benefit would enrich the consumer experience and consequently could attract additional consumers and secure repeat customers.

Additionally, it is well known in the art to search for fares by only examining fares for routes that pass through a small set of connection points between an origin and a destination. Then, by explicitly enumerating all the possible combinations of routes between the origin, connection points and destination, it is possible to find the least costly (in both time and price) route(s). However, this approach is still costly and is also inexact and inflexible. As new routes are scheduled or removed by carriers, all the predetermined connection point sets need to be recalculated. Even if only a limited number of connection points are provided, it may still be computationally prohibitive to explicitly enumerate even a limited set of route/fare combinations. Additionally, if only a limited number of connections are examined, then it may be possible to miss the optimal solution if the optimal solution passes through a connection point that is not among the predetermined connection points.

Therefore, there is a need for an approach to find best fares in a computationally non-prohibitive manner that is also exact and does not ignore possible route/fare combinations unless it is known that they are not best fares.

A general environment in which the invention operates is often referred to as a neural networks. Typical neural networks use layers of non-linear “hidden” units between inputs and outputs of the neural network. Each unit has a weight that is determined during learning, which is referred to as a training stage. In the training stage, a training set of data (for example, a training set of inputs each having a known output) is processed by the neural network. Thus, it is intended that the neural network learns how to provide an output for new input data by generalizing the information the neural network learns in the training stage from the training data. Generally, once learning is complete, a validation set is processed by the neural network to validate the results of learning. Finally, test data (for example, data for which generating an output is desired) can be processed by a validated neural network.

### BRIEF SUMMARY

According to one or more embodiments, a computer-implemented method for creating an optimal flight route for a user in real time using a neural network is illustrated and described. In one example, a computer-implemented method includes receiving a flight request, the request being for travel from a starting location in a starting region to a final destination in a destination region during a specified timeslot. The method further includes determining the cheapest flight from the starting location to a known hub in the starting region. The method further includes determining the cheapest flight from the final destination to a known hub in the destination region. The method then includes finding the cheapest flight from the hub in the starting region to the hub in the destination region.

In another embodiment, a computer implemented method for constructing an optimized flight path between a first location and a second location is disclosed. To begin, in one example, the method identifies a starting region associated with the first location and determines if the first location is classified as a hub in the starting region. If the first location is classified as a hub, the method designated the first location as a hub for constructing the optimized flight path between a first location and a second location. If the first location is not classified as a hub in the starting region, the method constructs a flight path from the first location to a hub in the starting region. Continuing with the method, the destination region of the second location is identified, and it is determined if the second location is classified as a hub in the destination region. If the second location is classified as a hub, the disclosed method designates the second location as a hub for constructing the optimized flight path between a first location and a second location. If the second location is not classified as a hub in the destination region, the disclosed method constructs a flight path from the second location to a hub in the destination region. Continuing, a flight path from the hub in the starting region is constructed to the hub in the destination region.

In yet another embodiment, a flight timeline is constructed between the first location and the second location and thereafter displayed. The first location and second location in the flight timeline is designated a user selectable hyperlink to offer the user an option of changing the flight information associated with the first and second locations.

In another embodiment, the flight timeline has at least one layover associated with the optimized flight path. The layover in the flight timeline is designated a user selectable hyperlink to offer the user an option of changing the flight information associated with the layover.

In still another embodiment, a detailed timeline of an optimized flight path between the first location and the second location is illustrated and described, where the disclosed detailed timeline includes one or more segment flight paths. The flight destination of each segment flight path of the optimized flight path are selectable by a user to display an alternate flight path to the segment flight path. The information associated with a segment flight path including flight departure location, flight arrival location, flight departure time, flight arrival time, layover duration and number of stops is displayed. The information for one or more alternate flight paths including flight departure location, flight arrival location, flight departure time, flight arrival time, layover duration and number of stops is also displayed. The difference in price between the segment flight path and the alternate flight path is shown.

Continuing, in another embodiment, the user may be given an option to extend the layover duration for any destination in a segment flight between the first location and the second location. The information for one or more alternate flight paths associated with the extended layover including flight departure location, flight arrival location, flight departure time, flight arrival time, layover duration and number of stops is displayed to a user. In one embodiment, an airline associated with the alternated flight path and a difference in price between the segment flight path and the alternate flight path is displayed. The user is given an option of choosing the alternate flight path. If chosen, an updated detailed timeline of an optimized flight path between the first location and the second location including the alternate flight path is displayed.

Other embodiments include a system and a computer program product.

The foregoing and other features, utilities and advantages of the invention will be apparent from the following more particular description of various embodiments of the invention as illustrated in the accompanying drawings and claims.

### BRIEF DESCRIPTION OF THE DRAWINGS

The examples described throughout the present document will be better understood with reference to the following drawings and description. The components in the figures are not necessarily to scale. Moreover, in the figures, like-referenced numerals designate corresponding parts throughout the different views.

FIG. 1 is an illustration of a representative portion of an internetwork such as the Internet;

FIG. 2 is a pictorial diagram of several devices connected to an internetwork which provide a client device also connected to the internetwork with the best fares in response to a fare query in accordance with the present disclosure;

FIG. 3 is a block diagram illustrating several of the components of a server shown in FIG. 2 used to optimize fare records in accordance with the present disclosure;

FIGS. 4 through 36 illustrate screenshots of software associated with various aspects of one embodiment of the present invention;

FIGS. 37 to 41 illustrate one embodiment of an algorithm of the software for creating a flight path from an origination to a destination;

FIG. 42 illustrates one embodiment of nodes in a neural network representing layover locations; and

FIGS. 43 and 44 illustrates one embodiment of a drag and drop method of the present software.

### BRIEF DESCRIPTION

In the following description, numerous specific details are set forth, such as examples of specific shapes, components etc., to provide a thorough understanding of the present invention. It will be apparent, however, to one skilled in the art that the present invention may be practiced without these specific details. In other instances, well known components or methods have not been described in detail, but rather in general terms to avoid unnecessarily obscuring the present invention. Thus, the specific details set forth are merely exemplary. The specific details may be varied from and still be contemplated to be within the spirit and scope of the present invention.

Reference to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Some portions of the detailed descriptions that follow are presented in terms of algorithms and symbolic representations of operations on data bits within a computer memory. These algorithmic descriptions and representations are the means used by those skilled in the data processing arts to convey the substance of their work most effectively to others. In general terms, an algorithm is conceived to be a self-consistent sequence of steps leading to a desired result. The steps of an algorithm require physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices. It is further contemplated within the scope of this invention that calculations can also be done mentally, manually or using processes other than electronic.

The present invention also relates to one or more apparatus for performing the operations herein. This apparatus may be specially constructed for the required purposes, or it may comprise a general-purpose computer selectively activated or reconfigured by a computer program stored within the computer. Such a computer program may be stored in a machine-readable storage medium, such as, for example, any type of disk including floppy disks, optical disks, CD-ROMs, magnetic-optical disks, read-only memories (ROMs), random access memories (RAMs), EPROMs, EEPROMs, magnetic or optical card, or any type of media suitable for storing electronic instructions and coupled to a computer system bus.

The algorithms and displays presented and described herein are not inherently related to any particular computer or other apparatus or apparatuses. Various general-purpose systems may be used with programs in accordance with the teachings, or it may prove convenient to construct more specialized apparatus to perform the required method steps. The required structure for a variety of these systems will become readily apparent from the description alone. In addition, the present invention is not described with reference to any particular programming language, and accordingly, a variety of programming languages may be used to implement the teachings of the illustrated invention.

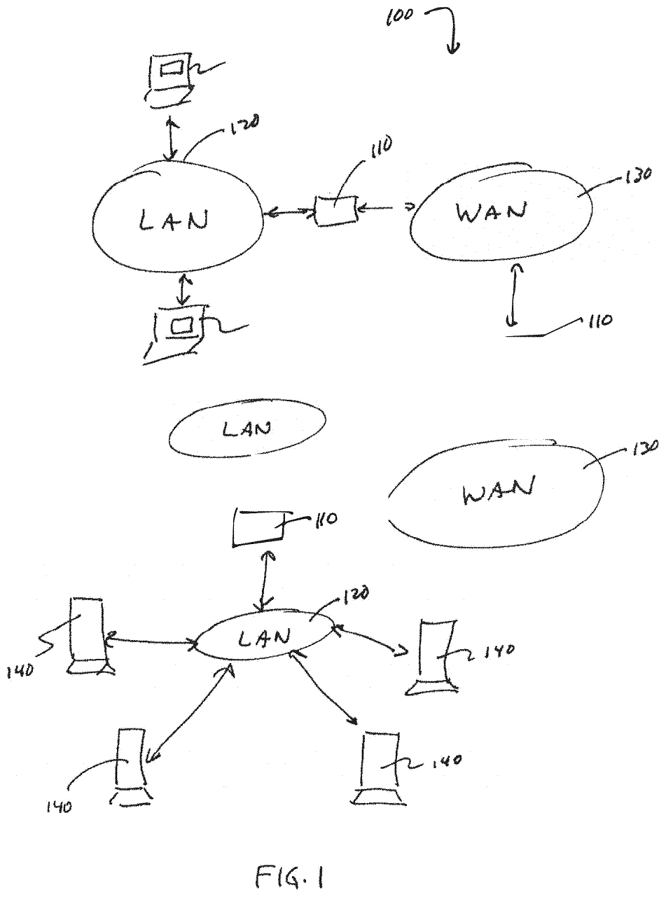

As previously explained, the capitalized term “Internet” refers to the collection of networks and routers that use the Internet Protocol (“IP”) to communicate with one another. A representative section of the Internet 100 is shown in FIG. 1 (Prior Art) in which a plurality of LANs 120 and WANs 130 are interconnected by routers 110. The routers 110 are generally special purpose computers used to interface one LAN or WAN to another. Communication links within the LANs may be twisted pair wire, or coaxial cable, while communication links between networks may utilize 56 Kbps analog telephone lines, or 1 Mbps digital T-1 lines and/or 45 Mbps T-3 lines. Further computers and other related electronic devices can be remotely connected to either the LANs 120 or the WAN 130 via a modem and temporary telephone link. Such computers and electronic devices 140 are shown in FIG. 1 as connected to one of the LANs 120 via dotted lines. It will be appreciated that the Internet comprises a vast number of such interconnected networks, computers, and routers and that only a small, representative section of the Internet 100 is shown in FIG. 1.

The Web, on the other hand, is a vast collection of interconnected, electronically stored information or “content” located on servers connected throughout the Internet 100. Many companies provide services and access to their content over the Internet 100 using the Web. For example, several companies provide travel services via the Internet 100 that enable customers to make reservations on-line for transportation and lodging. In accordance with the present disclosure, an optimized system and method are provided that determine the best available fare in response to a fare inquiry made by a user who is considering making a reservation or purchasing a ticket for transportation on-line. While air carriers and flights are used herein as illustrative examples for purposes of discussion of the present disclosure, it would be appreciated by those of ordinary skill in the art that the present disclosure applies equally as well to other forms of transportation as well, such as rail, road, water, or any other form of transportation amenable to reservations or fare inquiry. Furthermore, the present disclosure could be applied to pricing products which combine travel with related products such as hotel stays or car rentals; as selecting low price products from many possible combinations is important in this market. Still, further, the present disclosure could be applied to non-passenger travel as well, since package routing and delivery might benefit from best fare searching to increase efficient delivery of packages for the least cost.

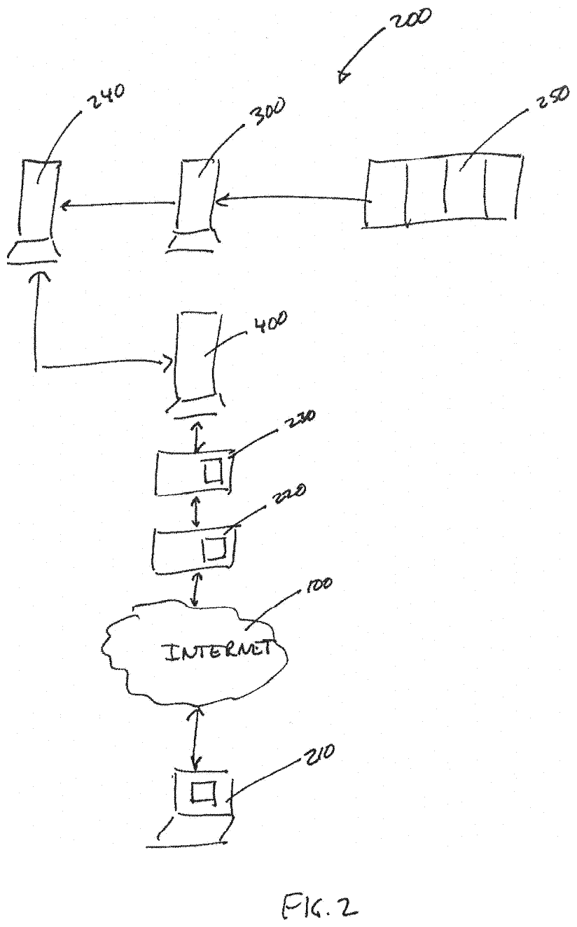

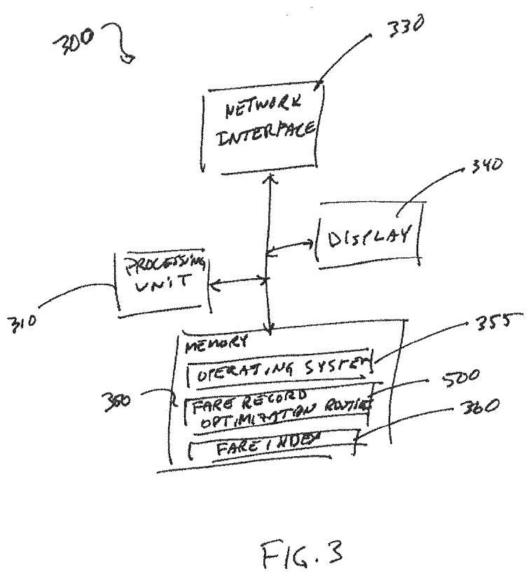

FIG. 2 illustrates a functional block diagram of a system 200 for determining the best fare in response to a query made by a user of the client device 210. The system 200 generally operates in a distributed computing environment comprising individual computer systems interconnected over a network (such as the Internet 100). However, it will be appreciated by those of ordinary skill in the art that the system 200 could equally function as a single, stand-alone computer system. In the described embodiment, a preprocess server 300, a file server 240 and a query server 400 are interconnected with one or more client devices 210, Web server(s) 220, and travel server(s) 230 over an internetwork, such as the Internet 100, or perhaps over an intranetwork. The preprocess server 300 is further described below in relation to FIG. 3. The system 200 also comprises one or more connections to a CRS 250, which as noted above, is a system/service for providing up-to-date fare, schedule, and availability information for transportation services. Those of ordinary skill in the art will appreciate that more or less devices may be used in the exemplary system 200. For example, file server 240 may not be necessary if the query server 400 receives information from the CRS 250 directly. In another example, the preprocess server 300 may not be necessary if the query server 400 or file server 240 were equipped to preprocess fare information locally.

FIG. 3 depicts several of the key components of the preprocess server 300. Those of ordinary skill in the art will appreciate that the preprocess server 300 may include many more components than those shown in FIG. 3. However, it is not necessary that all of these generally conventional components be shown in order to disclose an illustrative embodiment for practicing the present disclosure. As shown in FIG. 3, the preprocess server 300 includes a network interface 330 for connecting to the Internet 100. Those of ordinary skill in the art will appreciate that the network interface 330 includes the necessary circuitry for such a connection and is also constructed for use with the TCP/IP protocol or the next generation protocols such as the Internet Inter-ORB Protocol (“HOP”).

The preprocess server 300 also includes a processing unit 310, a display 340, and a memory 350 all interconnected along with the network interface 330 via a bus 320. The memory 350 generally comprises a random access memory (“RAM”), a read-only memory (“ROM”) and a permanent mass storage device, such as a disk drive. The memory 350 stores the program code necessary for preprocessing fare records in accordance with the present disclosure using a fare record optimization routine 500. In addition, memory 350 also stores optional temporary fare record storage referred to as a fare index 360 and an operating system 355. It will be appreciated that these software components may be loaded from a computer-readable medium into memory 350 of the preprocess server 300 using a drive mechanism (not shown) associated with the computer-readable medium, such as a floppy, tape, or DVD/CD-ROM drive or via the network interface 330.

Although an exemplary preprocess server 300 has been described that generally conforms to a conventional general purpose computing device, those of ordinary skill in the art will appreciate that a preprocess server 300 may be any of a great number of devices capable of communicating with the Internet 100 or with the query server 400.

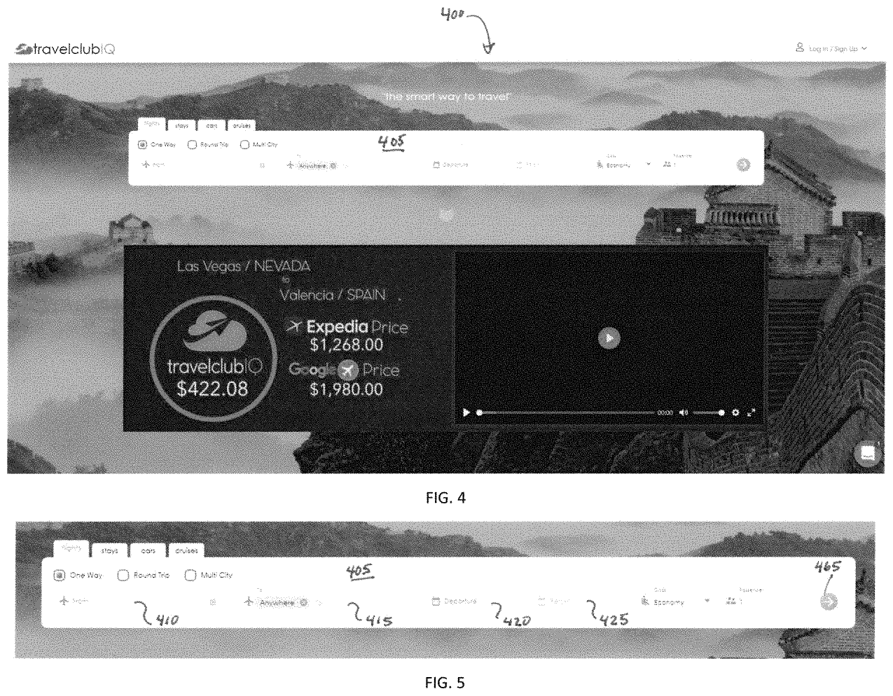

FIGS. 4 through 37 illustrate screenshots of software associated with various aspects of one embodiment of the present invention.

In accordance with one embodiment, FIG. 4 illustrates a splash page for the software that is displayed to the user. Typically, the splash page 400 is the first page shown when the user types in the web address or opens an app on a cell phone. The software provides the user with the opportunity to enter their login information or sign up for an account. In the illustrated embodiment and as shown in FIG. 5, a flight search bar 405 is provided to the user for entering the basic information about the desired flight. The user may select the “from” or first location 410 and the “to” or second location 415. In one embodiment, when the user begins entering the locations, the system recognizes what the user is typing and provides the user with suggested regions, cities, and airports. The software also provides departure date 420 and return date 425. As shown the user may select a One Way, Round Trip, or Multi City option. The flight search bar 405 provides the user with the option to select the class of airfare, such as economy, first class or business class. Finally, the user may select the number of passengers.

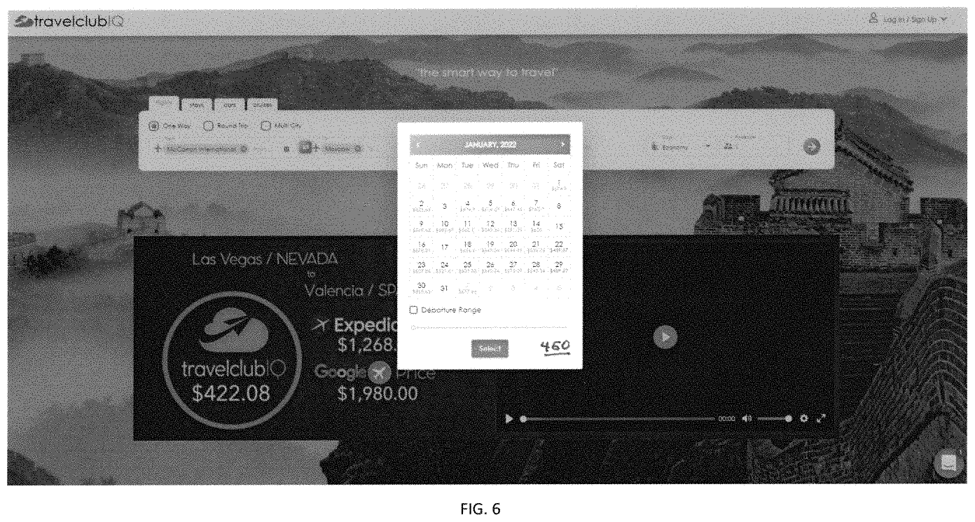

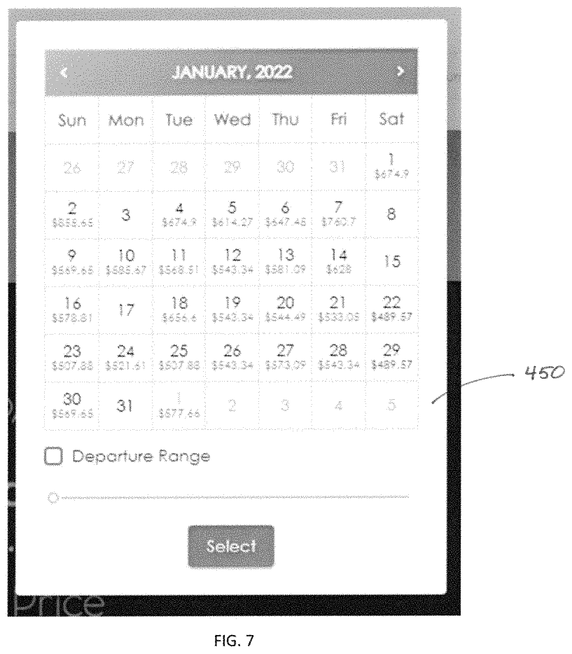

In the example shown in FIG. 6, the software generates a graphical calendar for the user selected first location and second location for a desired flight path. In one operation, when the departure date is selected for a “One Way” option, as illustrated in FIG. 7, the software generates a graphical calendar 450 illustrating one example of a fare for each day of the month for the desired starting and ending locations for the departure date. The user may then select a particular date of travel from the graphical calendar 450, which is entered into the flight search bar.

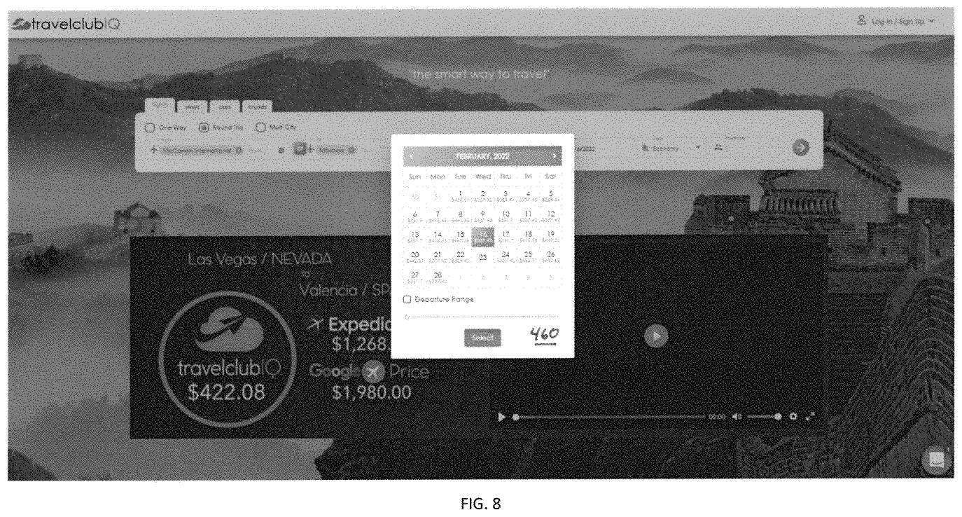

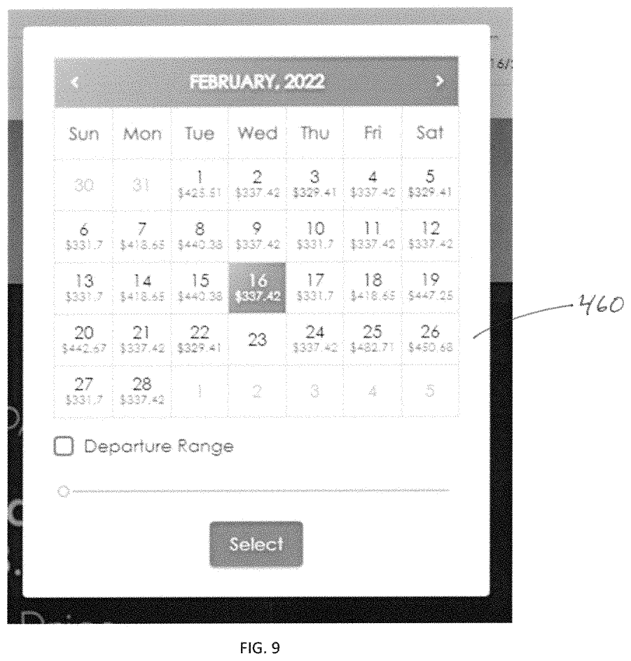

If the “Round Trip” option is selected by the user, as shown in FIG. 8, the user may select the return date and a graphical calendar 460 is generated showing sample fares for the return date, based upon the previously selected departure date. As shown in FIG. 9, the user may then select a particular date of travel for the return flight in the graphical calendar 460, which is entered into the flight search bar.

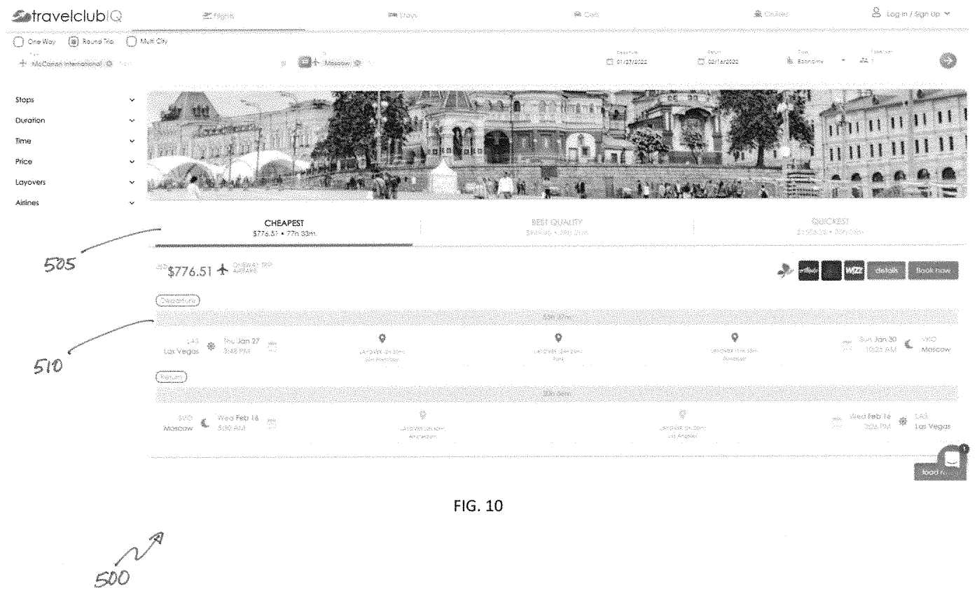

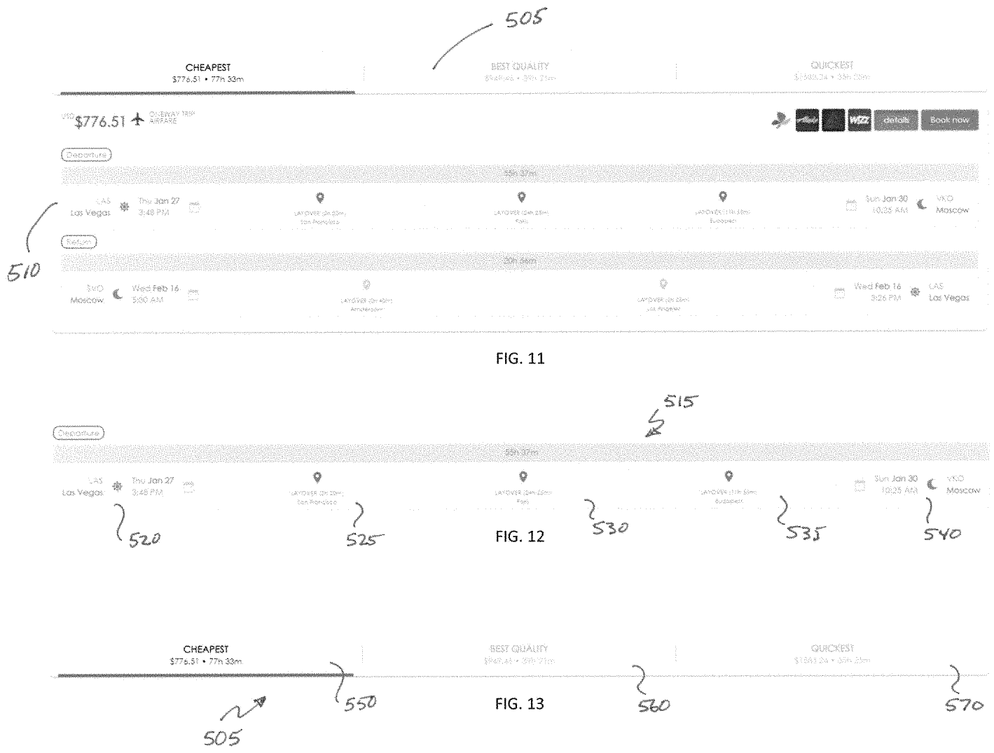

FIGS. 10-13 illustrate one example of a potential optimized flight path, including a resulting trip travel timeline, for the user entered originating location and destination location based upon additional information entered as illustrated and described in FIGS. 4-9. Once the user selects the generate button 465 after entering information into the flight search bar 405, as illustrated in FIG. 10, the computer implemented method returns the flight path presentation screen 500 with various information about the flight path generated by the software of one embodiment of the present invention. More specifically, the software uses an algorithm more particularly described below to generate multiple flight path options, and the user may filter the viewed results according to user selected criteria. In the illustrated example shown specifically in FIG. 11, the user is presented with three selectable options 505 relating to price, quality, and timing. As shown in FIG. 11, the user is also provided with the details of at least one flight path 510 between the user selected first location and second location for a round trip flight, including but not limited to, price, airlines, and trip timeline for the flight plan.

FIG. 12 illustrates the trip timeline 515 for the outbound portion of the round-trip flight example in greater detail. As shown, trip timeline 515 comprises the originating location 520, the destination location 540, and multiple layover locations 525, 530, 535. As one of ordinary skill in the art understands and appreciates, the number of layover locations varies depending upon the regions of the starting location and ending location and identities of the hubs in each region. One embodiment of algorithm associated with the present invention identifies the hubs in the various regions and generates multiple flight paths between the origin and destination based upon a multitude of factors in a graph database as discussed below. In the illustrated example, the illustrated outgoing flight path originates in Las Vegas 520 and ends in Moscow 540 stopping three times in San Francisco 525, Paris 530, and Budapest 535.

FIG. 13 illustrates in greater detail one way the user may be presented with three selectable options 505 relating to price, quality, and timing. More specifically, in the illustrated the user may select the cheapest option 550, the best quality option 560, and the quickest option 570. One skilled in the art will appreciate that any number of use selectable options may be presented to the user without departing from the intended scope and spirit of the invention. Once one of the three selectable options is chosen by the user, a trip timeline is generated corresponding to what the user wants to see. For example, if the user selects the quickest flight 570, the software will display the fastest route between the originating location 520 and destination location 540, including the lowest number of layover locations, if applicable.

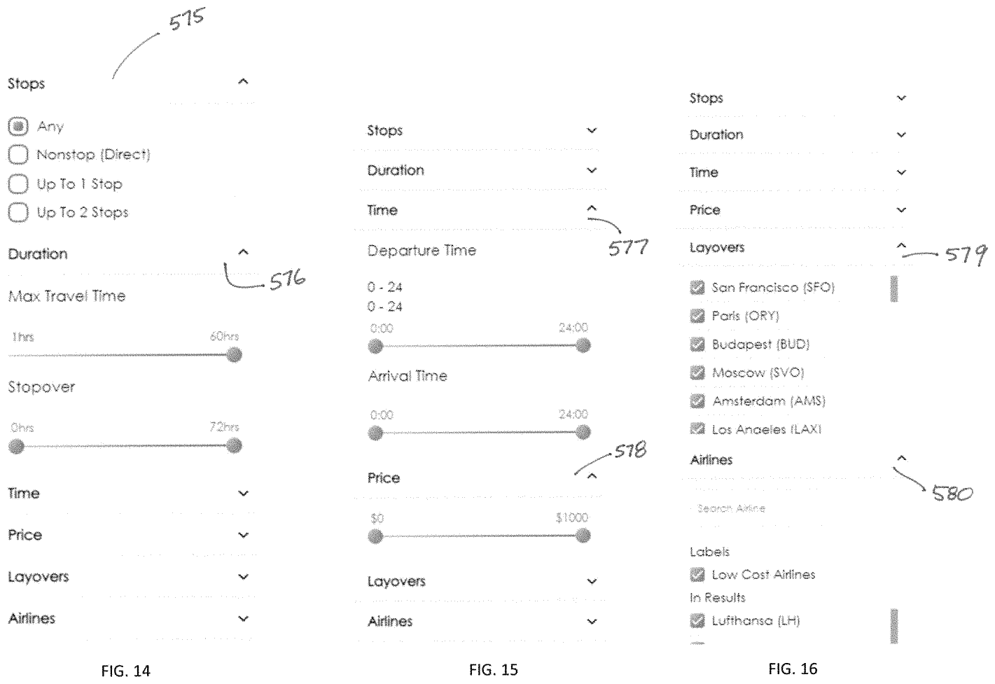

As shown in FIGS. 14-16, the user is provided with options to filter the results. For example, as illustrated in FIG. 14, the user may designate the number of stops 575 or maximum travel time 576 to further give the user the ability to choose a flight that suits their needs. Continuing, the user may further designate the specific departure and arrival time 577 and maximum price the user is willing to pay 578. Moreover, the user can specify specific layover locations 579 or specific airlines 580 associated with the flight.

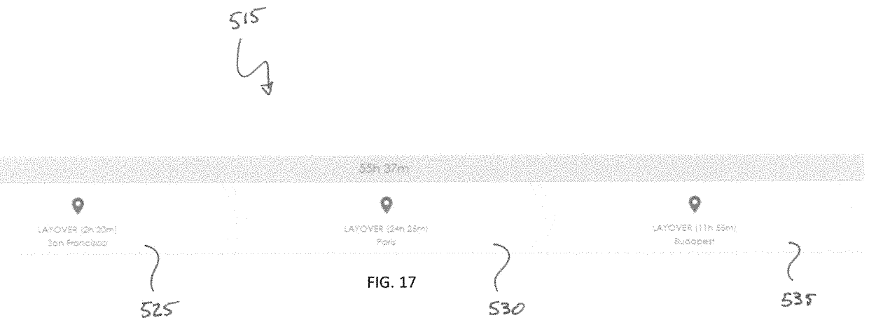

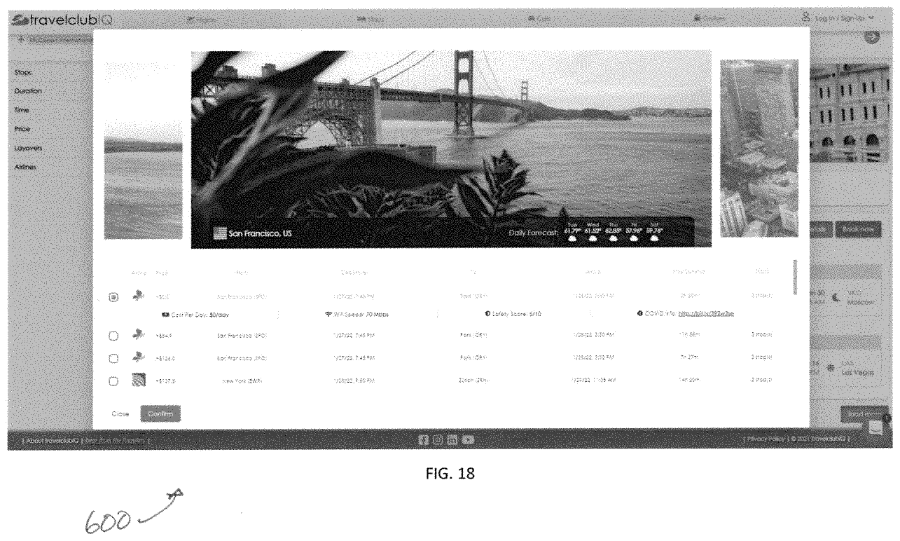

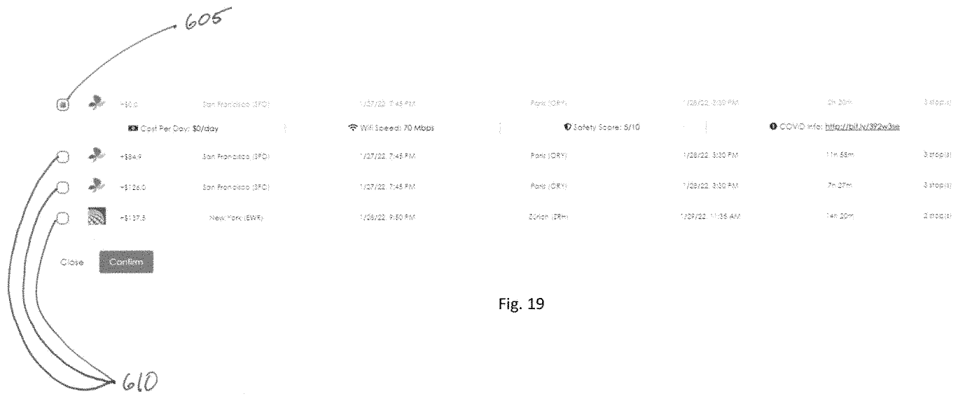

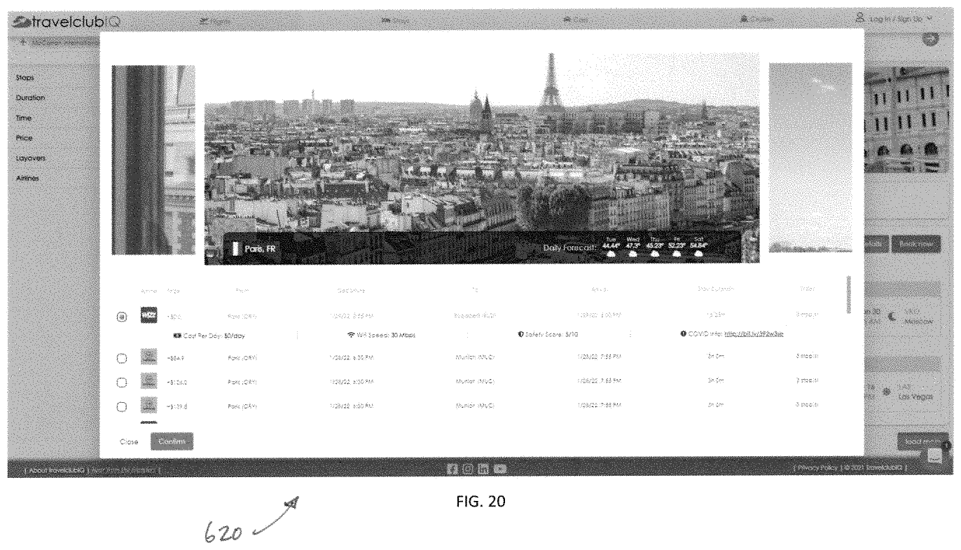

FIG. 17 illustrates a further example of a trip travel timeline 515 from FIG. 11, specifically, the layover locations associated with the flight path generated by the user entered originating location and destination location. Each layover location 525, 530, 535 is user selectable, such as a hyperlink or similar, such that the user may drill down into a chosen location and view the information associated with the layover and potentially change some of the information. For example, FIG. 18 shows the page 600 presented to a user in response to selecting the San Francisco layover location 525. FIG. 19 shows an expanded version of the information including the existing flight 605 shown in FIG. 10 and potential changes 610. In the illustrated example, potential changes 610 show the change in price, the originating city and the next city in the leg, the departure time and arrival time including total travel time and the number of stops.

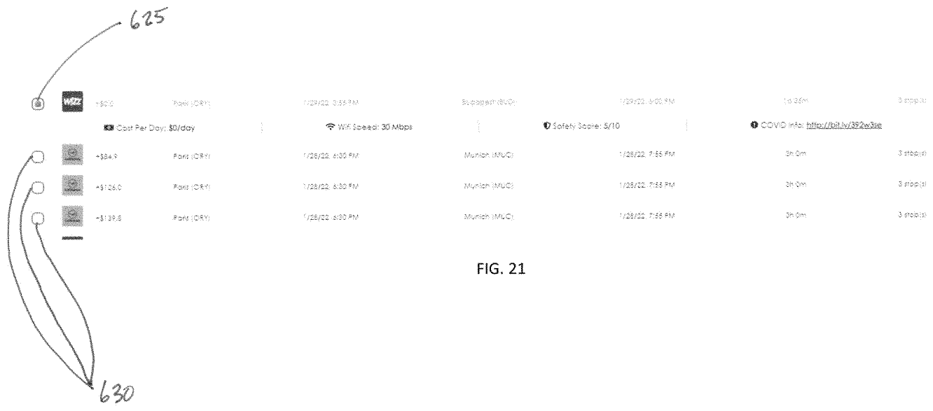

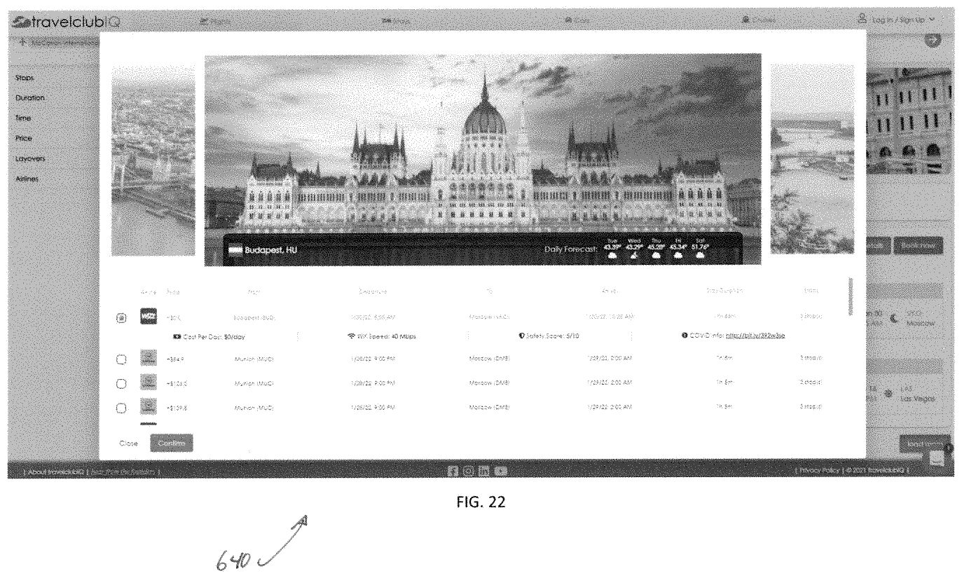

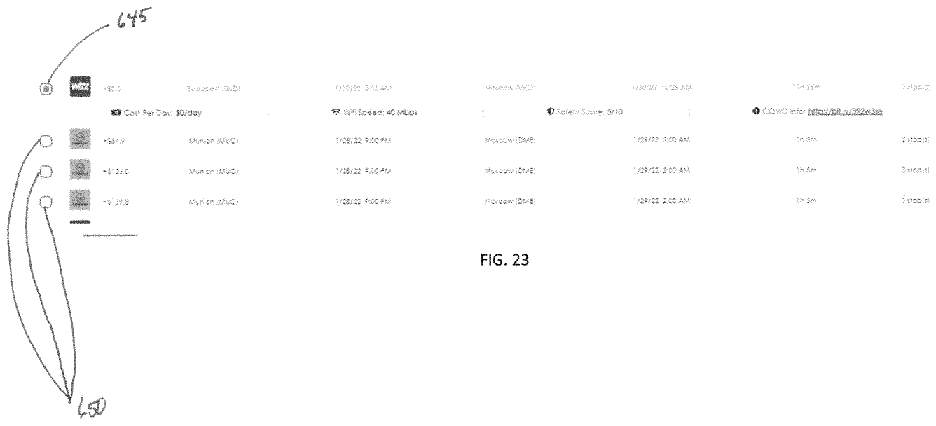

Continuing, FIG. 20 shows the page 620 presented to a user in response to selecting the Paris layover location 530. FIG. 21 shows an expanded version of the information including the existing flight 625 shown in FIG. 10 and potential changes 630. In the illustrated example, potential changes 630 show the change in price, the originating city and the next city in the leg, the departure time and arrival time including total travel time and the number of stops. FIG. 22 shows the page 640 presented to a user in response to selecting the Budapest layover location 535. FIG. 23 shows an expanded version of the information including the existing flight 645 shown in FIG. 10 and potential changes 650. In the illustrated example, potential changes 650 show the change in price, the originating city and the next city in the leg, the departure time and arrival time including total travel time and the number of stops.

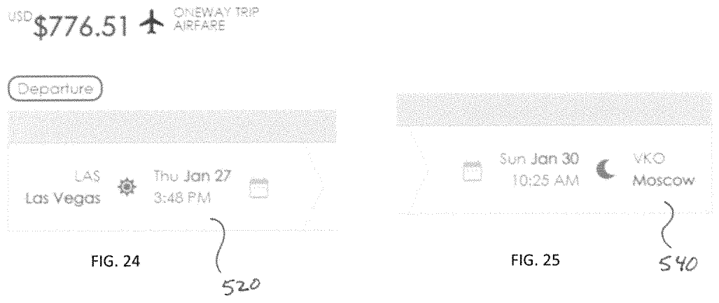

FIGS. 24 and 25 show the originating location 520 with departure date and time and the destination location 540 with the arrival date and time respectively. Like layover locations 525, 530, 535, originating location 520 and destination location 540 are also user selectable, such as a hyperlink or similar, such that the user may drill down into a chosen location and view the information associated with the location and potentially change some of the information if desired.

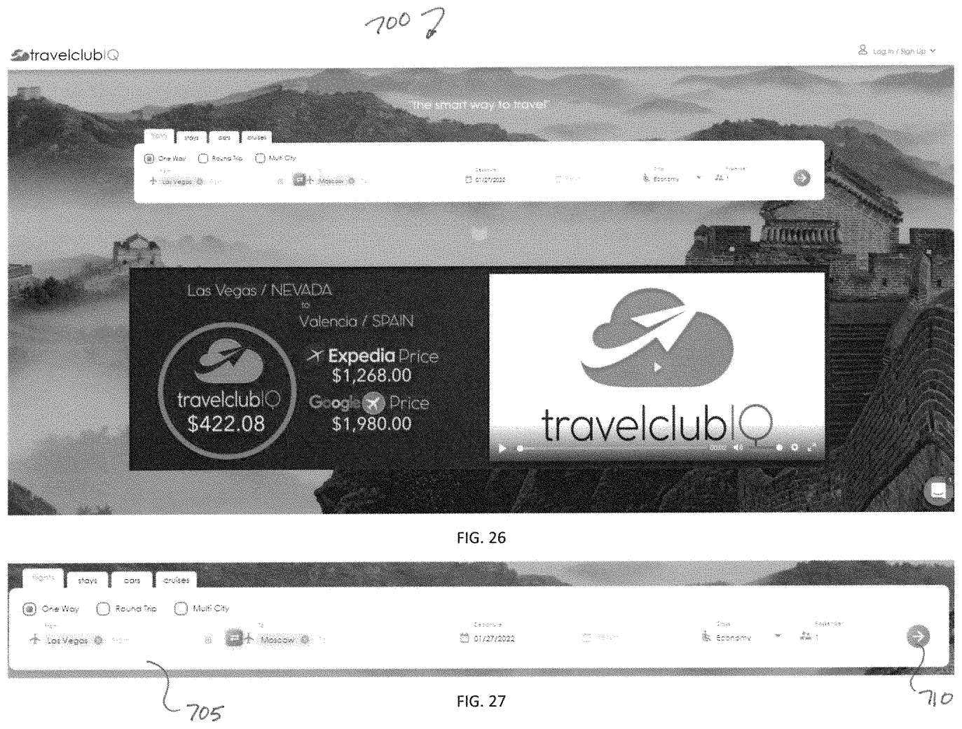

In accordance with one embodiment, FIG. 26 illustrates a splash page 700 for the software that is displayed to the user. In the illustrated embodiment and as shown in FIG. 27, a flight search bar 705 is provided to the user for entering the basic information about the desired one-way flight. The user may select the “from” or first location and the “to” or second location. In the illustrated example, a user has selected Las Vegas, Nev., USA as the originating location and Moscow, Russia as the destination location.

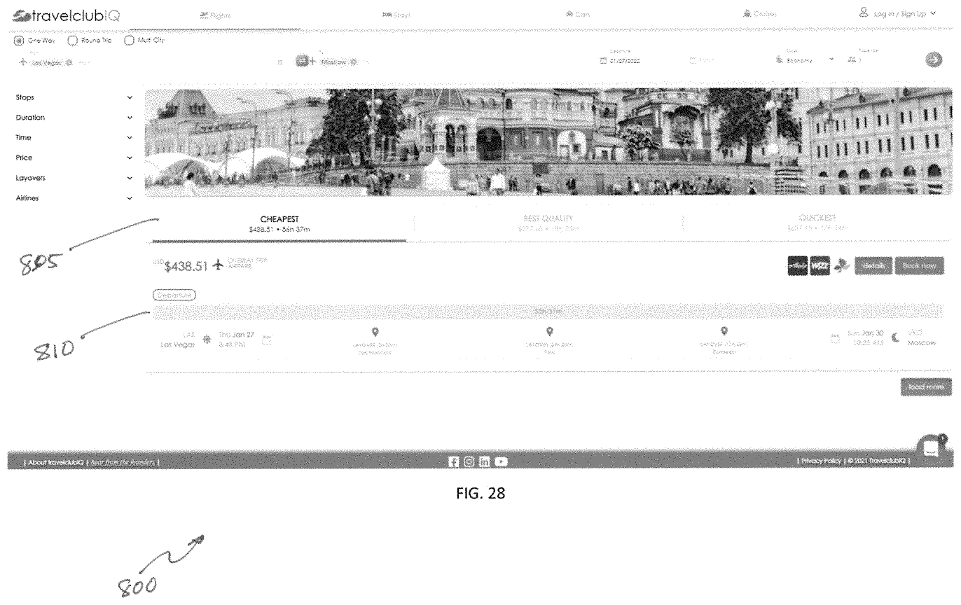

After the user selects the generate button 710 after entering information into the flight search bar 705, as illustrated in FIG. 28, the computer implemented method returns a flight path presentation screen 800 with various information about a particular flight path generated by the software of one embodiment of the present invention. Again, the software generates multiple flight path options, one is shown and the user may filter the viewed results according to user selected criteria. In the illustrated example shown, the user is presented with three selectable options 805 relating to price, quality, and timing. As shown, the user is also provided at least one flight path timeline 810 between the first location Las Vegas and second location Moscow for a one-way trip. Flight path timeline 810 also shows layover locations San Francisco, Paris and Brussels, which are user selectable, such as a hyperlink or similar, such that the user may drill down into a chosen location and view the information associated with the layover.

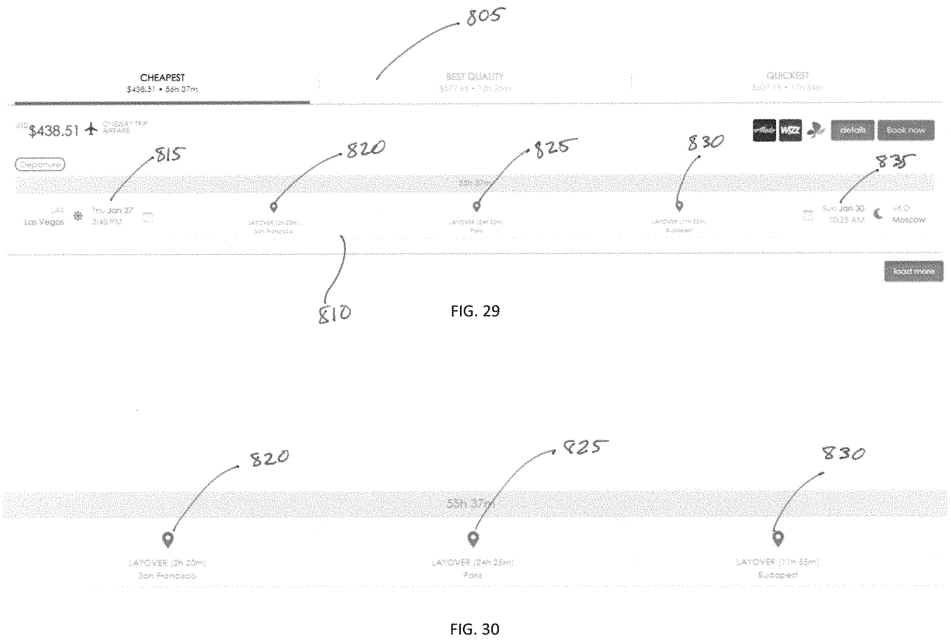

FIG. 29 illustrates the trip timeline 810 for the one-way flight example in greater detail. As shown, trip timeline 810 comprises the originating location 815, the destination location 835, and multiple layover locations 820, 825, 830. As one of ordinary skill in the art understands and appreciates, the number of layover locations varies depending upon the regions of the starting location and ending location and identities of the hubs in each region. One embodiment of algorithm associated with the present invention identifies the hubs in the various regions and generates multiple flight paths between the origin and destination based upon a multitude of factors in a graph database as discussed below. In the illustrated example, the illustrated outgoing flight path originates in Las Vegas 815 and ends in Moscow 835 stopping three times in San Francisco 820, Paris 825, and Budapest 830.

FIG. 30 illustrates a further example of a trip travel timeline 810 from FIG. 28, specifically, the layover locations associated with the flight path generated by the user entered originating location and destination location. Each layover location 820, 825, 830 is user selectable, such as a hyperlink or similar, such that the user may drill down into a chosen location and view the information associated with the layover and potentially change some of the information.

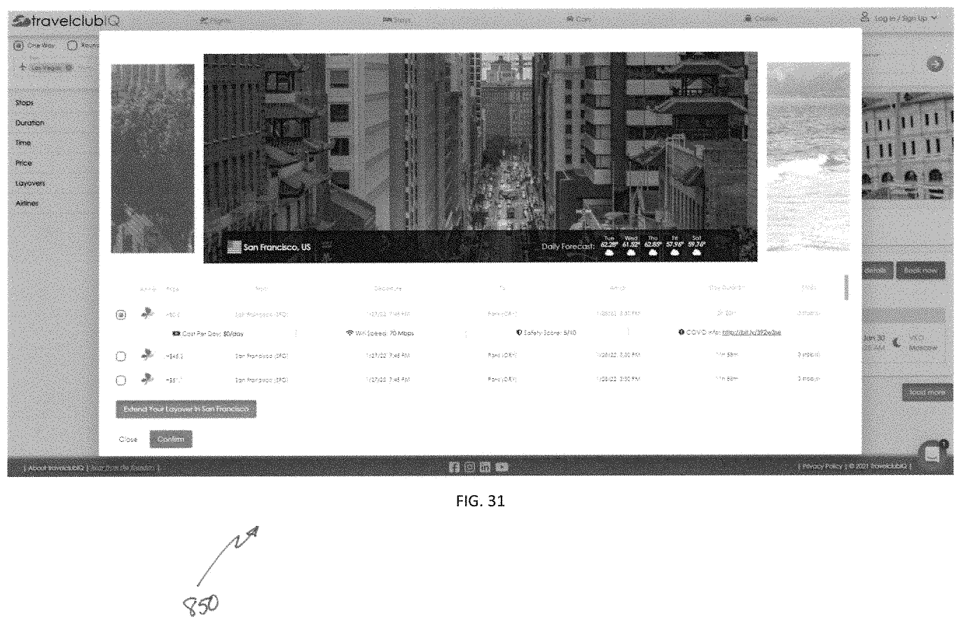

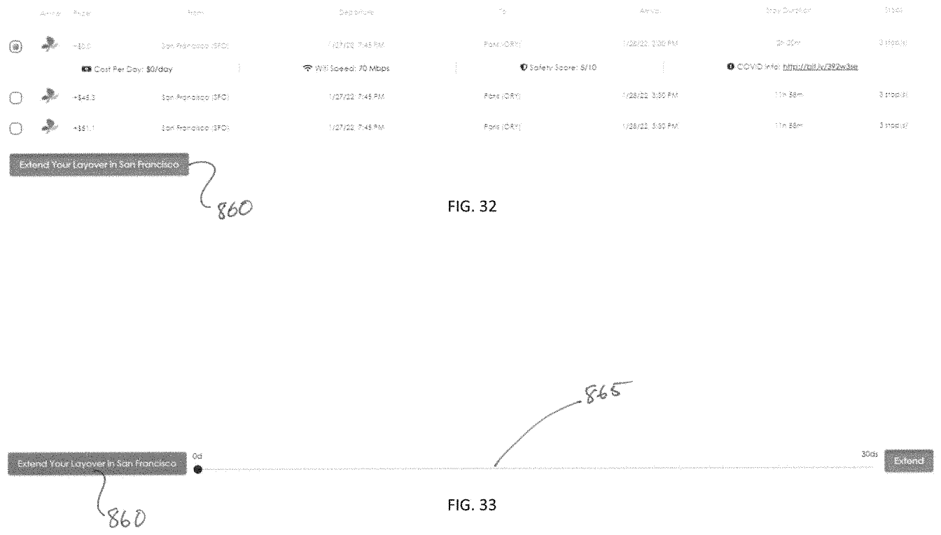

For example, FIG. 31 shows the page 850 presented to a user in response to selecting the San Francisco layover location 525. FIG. 32 shows an expanded version of the information including the existing flight information shown in FIG. 28 and potential changes. In the illustrated example, potential changes show the change in price, the originating city and the next city in the leg, the departure time and arrival time including total travel time and the number of stops. The user is also given an option of extending a layover 860. In the illustrated example of FIG. 33, the user may extend the layover in San Francisco 860. In response, the software provides a sliding scale. In the embodiment shown, the user may extend the layover for up to 30 days. One skilled in the art will appreciate that any number of days may be presented to the user without departing from the intended scope and spirit of the invention.

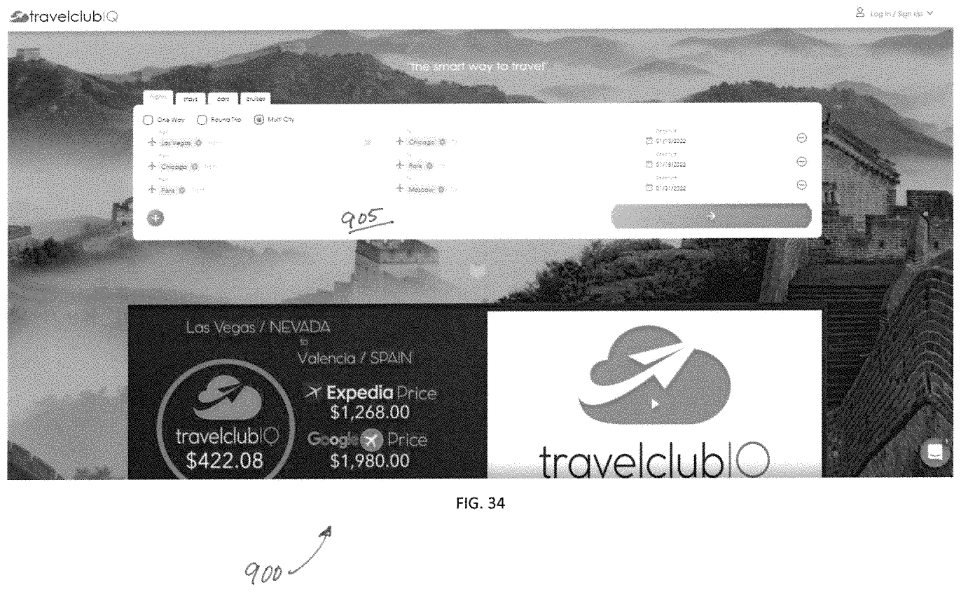

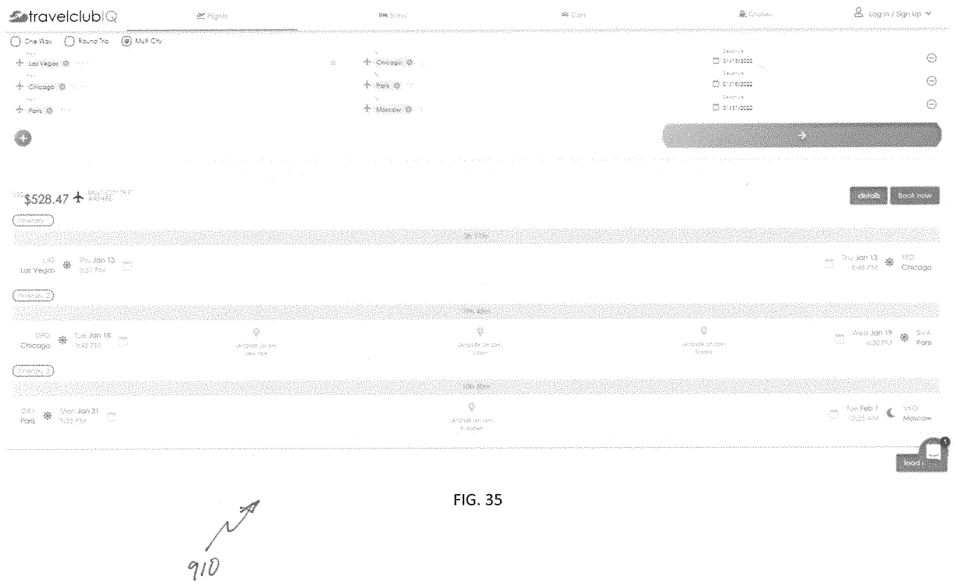

In accordance with one embodiment, FIG. 34 illustrates a splash page 900 for the software that is displayed to the user. In the illustrated embodiment, a flight search bar 905 is provided to the user for entering the basic information about the desired multi city flight. The user may select the “from” or first location and the “to” or second location. In the illustrated example, a user has selected Las Vegas, Nev., USA as the originating location, Chicago, Ill., USA as a first location, Paris, France as a second location, and Moscow, Russia as the destination location. Continuing with the multi city example, after the user selects the generate button after entering information into the flight search bar 905, as illustrated in FIG. 35, the computer implemented method returns a flight path presentation screen 910 with various information about a particular flight path generated by the software of one embodiment of the present invention.

Again, the algorithm associated with the software generates multiple flight path options. In the illustrated embodiment, one is displayed, and the user may filter the viewed results according to user selected criteria. As shown for the multi city example, the user is also provided at least one flight path timeline 810 between Las Vegas and Chicago, Chicago and Paris, and Paris and Moscow. Each flight path timeline also shows layover locations, which may be user selectable, such as a hyperlink or similar, such that the user may drill down into a chosen location and view the information associated with the layover.

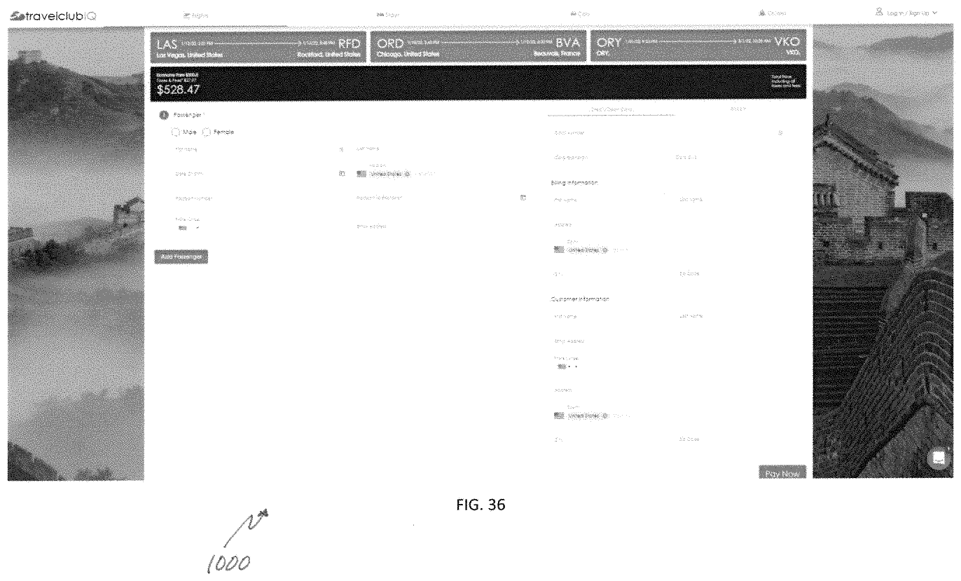

FIG. 36 illustrates one example of a purchase page 1000 once a decision is made to buy a ticket.

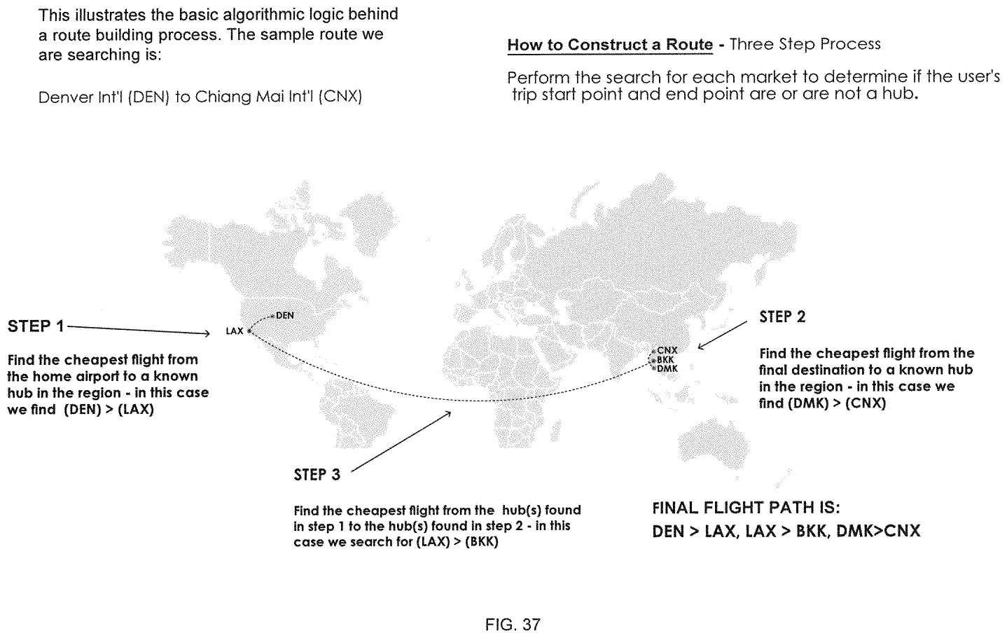

FIGS. 37 to 41 illustrate the general algorithm of the software for creating a flight path from an origination to a destination. With the full integration of data from twice as many carriers, negating limiting airline alliances restrictions we then apply a modified version of Dijkstra's algorithm. From there we easily identify the most optimal flight path—by identifying lowest cost per mile (i.e., CPM) and alignment with 50+ additional criteria within segments between origination A to destination B, indicated by the weighted nodes in our graph. Our data aggregation, organization and filtration systems allow our graph database to provide ample intelligence to adjust the weighting of all nodes across the graph in real time. When a node creates a lower CPM with decreased total travel time, or additional social data has adjusted your alignments with locations will be weighted heavier, being seen as a favorable option.

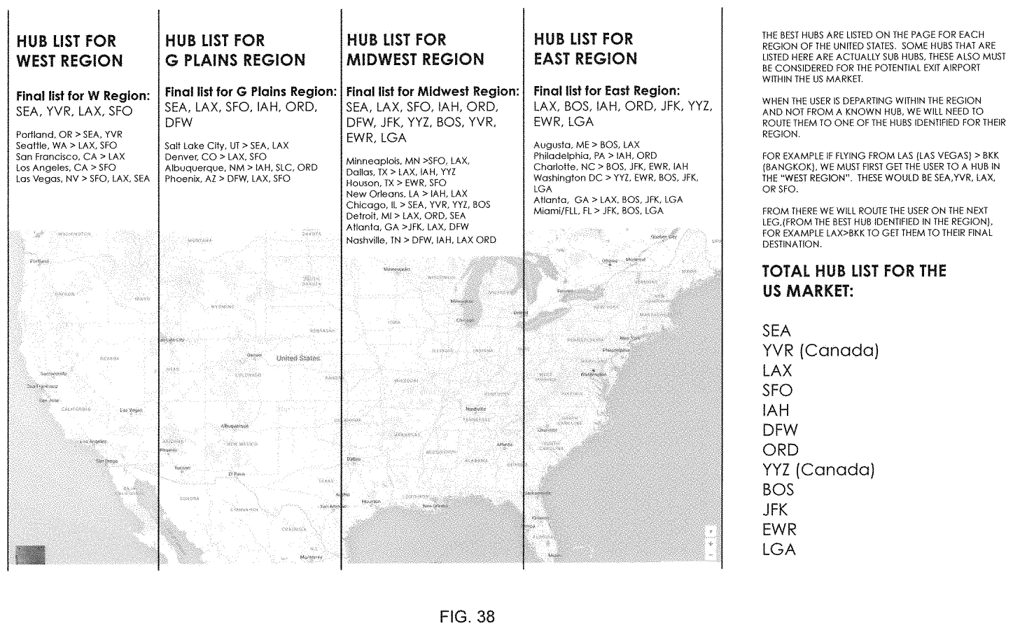

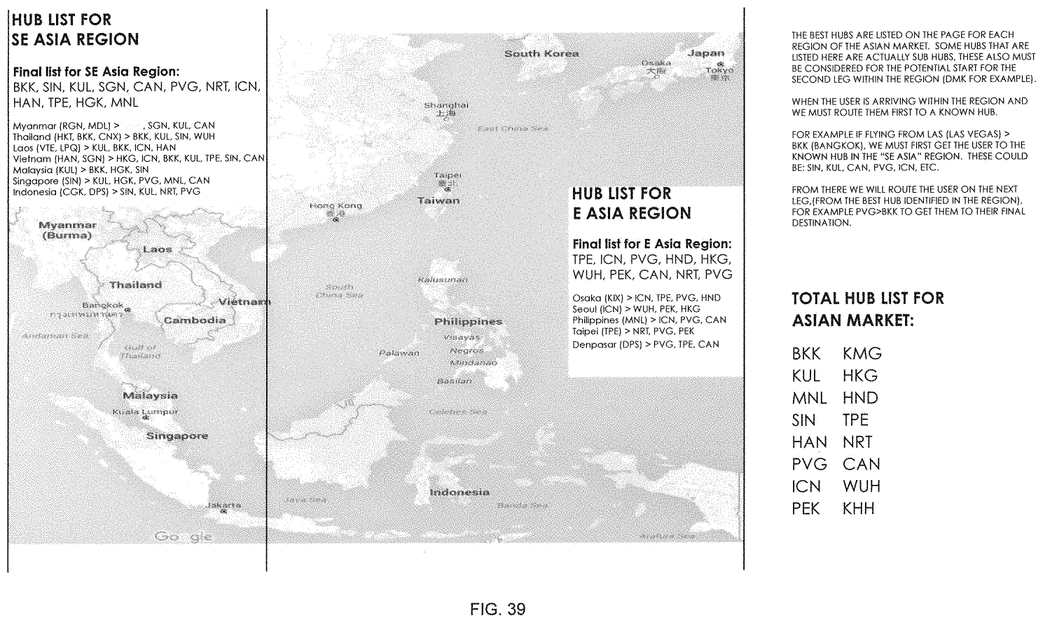

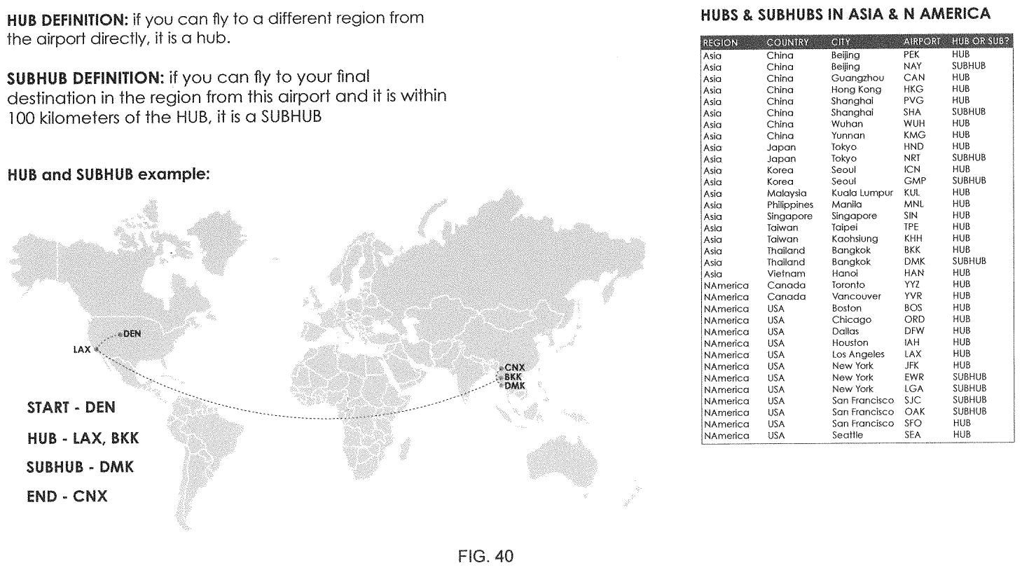

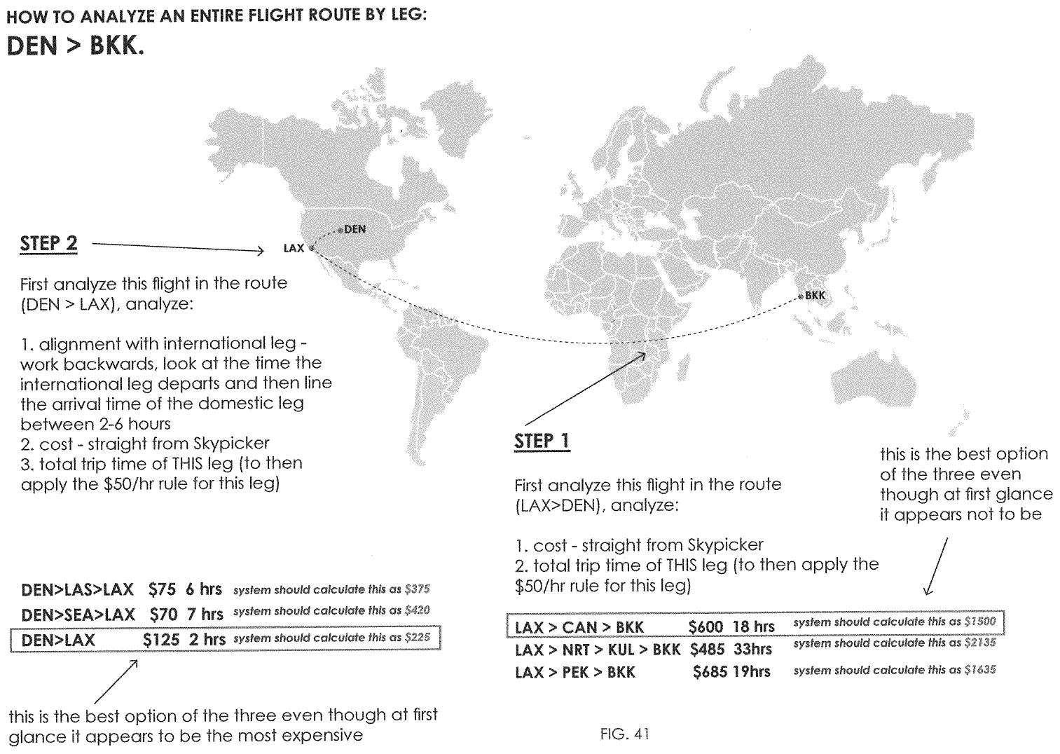

As shown in FIG. 37, an optimized flight path between a first location (DEN) and a second location (CNX) is disclosed. To begin, in one example, the method identifies a starting region associated with the first location (DEN) and determines if the first location is classified as a hub in the starting region. If the first location is classified as a hub, the method designates the first location as a hub for constructing the optimized flight path between a first location and a second location. If the first location is not classified as a hub in the starting region, as is the case in the illustrated example, the method constructs a flight path from the first location (DEN) to a hub (LAX) in the starting region. Continuing with the method, the destination region of the second location (CNX) is identified, and it is determined if the second location is classified as a hub in the destination region. If the second location is classified as a hub, the disclosed method designates the second location as a hub for constructing the optimized flight path between a first location and a second location. If the second location (CNX) is not classified as a hub in the destination region, as is the case in the illustrated example, the disclosed method constructs a flight path from the second location (CNX) to a hub (DMK) in the destination region. Continuing, a flight path from the hub in the starting region (LAX) is constructed to the hub in the destination region (BKK), since the algorithm determines that a hub (BKK) is within a specified distance from another regional hub (DMK) and the flight from a first regional hub (LAX) to a second regional hub (BKK) is the cheapest. FIGS. 38 and 39 list hubs and subhubs in the originating U.S. region and destination S.E. Asia regions respectively. Continuing with the example of FIG. 37, FIG. 40 provides a typical hub and subhub example with accompanying hub and subhub definition. FIG. 41 provides one example of the manner in which the algorithm analyzes an entire flight route on a leg-by-leg basis.

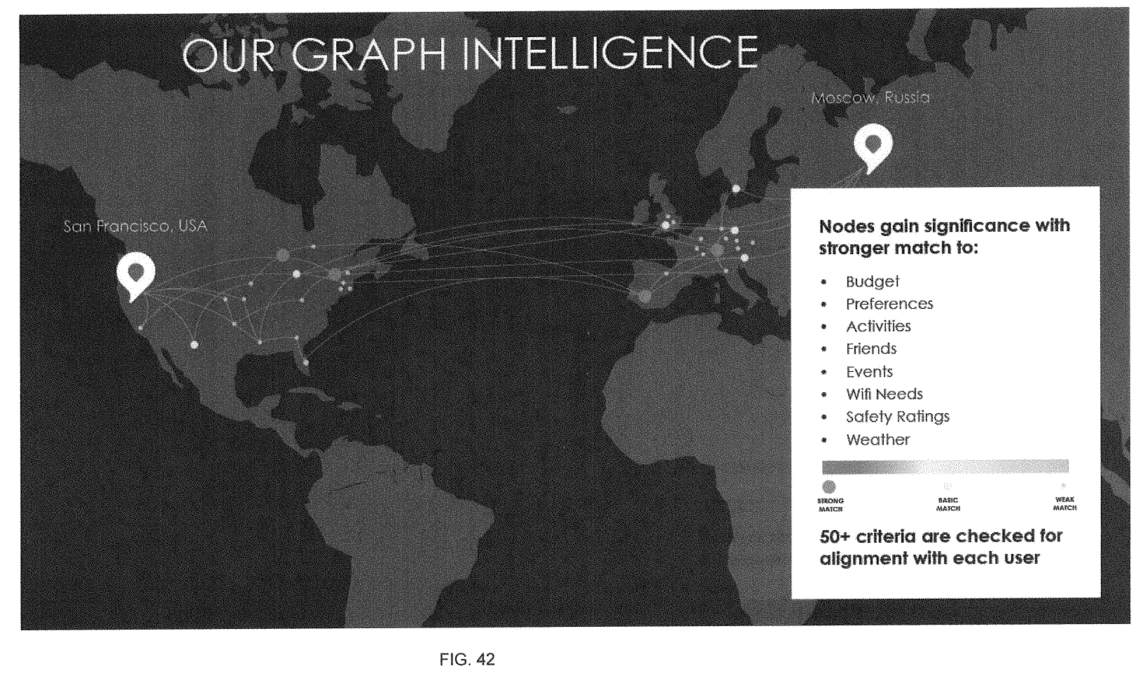

FIG. 42 illustrates nodes in a neural network representing layover locations. Graph databases consist of nodes and lines, each contains specific sets of data as it's all relationally dependent—in our flights graph database (FGD) the nodes contain all the relevant information for the airport: # of carriers (airlines), passengers per day, flights per day, latitude, longitude coordinates. The lines contain data for each flight segment that exists between the nodes—this information includes, for example: carrier, flight times, frequency, pricing, availability, seats, baggage pricing, and ancillaries. In one embodiment, the software only shows layover airports that are optimally positioned between A & B, based generally upon embedded geo-location information (latitude, longitude) which is stored within the nodes of our FGD. In another embodiment, a location graph database (LGD) stores a range of information for each city: cost per day, Wi-Fi speed, safety, accommodations, activities, temperatures, best time to go, covid safety ratings, images, events, etc. In another embodiment, a social graph database (SGD) cross references any/all social media accounts connected to our system through a user's profile—to build a social graph over laying the flight routing and location specific graphs, e.g., FGD and LGD respectively. The social graph integration allows you to see where your friends, colleagues and family members have traveled to and where they are all currently located at the time of booking.

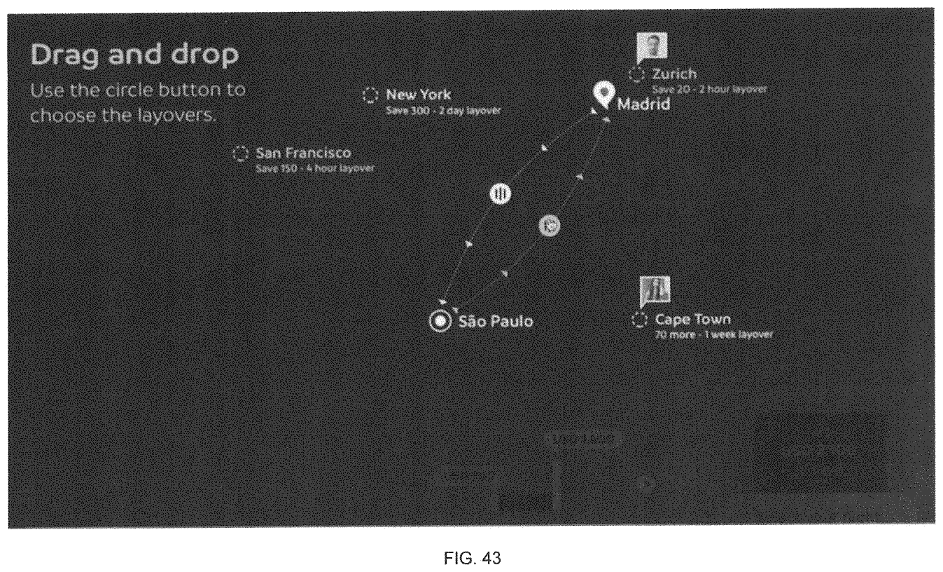

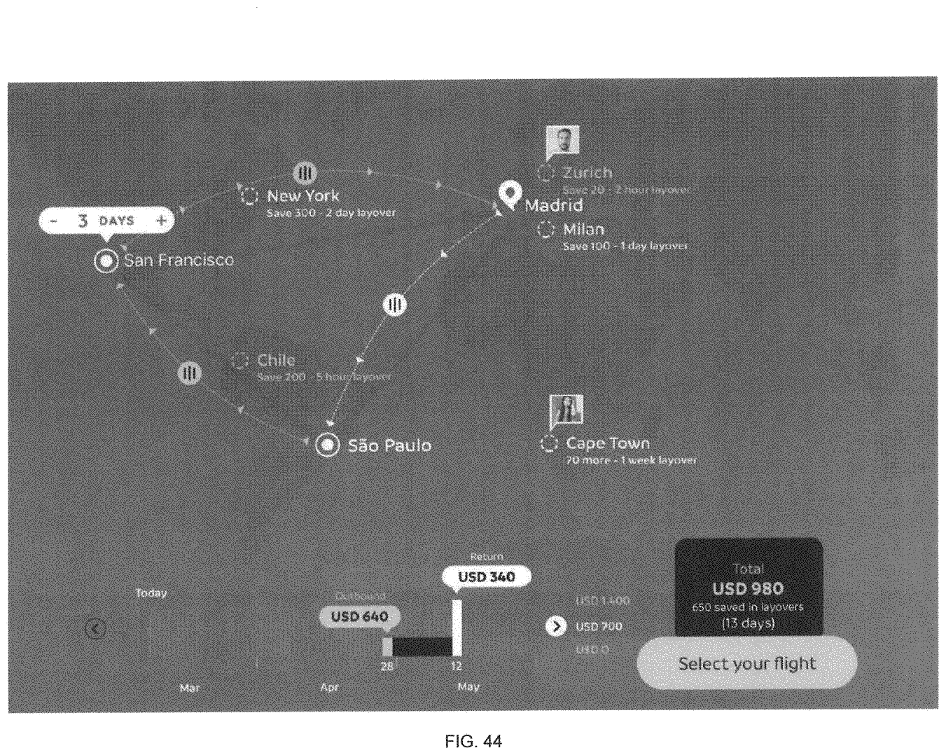

FIGS. 43 and 44 illustrates a drag and drop method of the present software. A drag and drop feature you can drag places in to your timeline and it will populate flight options you click a flight option and then you can modify that as well within the route there are layovers and every single layover has a blue pin on the top of it every blue pen you can click and modify so if you click, it will open a window and the window opens it shows you all of the options for that specific layover so you can layover in Amsterdam or Paris. And when you see the list of the places you can click on each place and it will tell you the cost per day the Wi-Fi the safety score the Covid ratings, and then you have the option to select and extend the layover for any period of time and there is a slider there that allows you to drag across shows the number of days on the top and it shows the price difference on the bottom so you can see that she stay in Paris for seven days it will cost you an additional $12 for example or if you chose to stay in there for three months it might not even be a cost difference that's the beauty of this site it builds all of the routes in real time. Nothing is static or stagnant, the entire site has several bots that are searching the web to determine the pricing at every single moment across all websites. We know what our savings are at all times against all other websites online.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention.

I claim:

1. A computer implemented method for constructing an optimized flight path between a first location and a second location, said method comprising:
identifying a starting region associated with the first location;
determining if the first location is classified as a hub in the starting region;
if the first location is not classified as a hub in the starting region, constructing a flight path from the first location to a hub in the starting region;
identifying a destination region of the second location;
determining if the second location is classified as a hub in the destination region;
if the second location is not classified as a hub in the destination region, constructing a flight path from the second location to a hub in the destination region; and
constructing a flight path from the hub in the starting region to the hub in the destination region.

2. The computer implemented method of claim 1, further comprising,
constructing a flight timeline between the first location and the second location;
displaying the flight timeline;
making the first location in the flight timeline a user selectable hyperlink to offer the user an option of changing the flight information associated with the first location; and
making the second location in the flight timeline a user selectable hyperlink to offer the user an option of changing the flight information associated with the second location.

3. The computer implemented method of claim 2, further comprising making at least one layover in the flight timeline a user selectable hyperlink to offer the user an option of changing the flight information associated with the at least one layover.

4. The computer implemented method of claim 1, further comprising displaying the details of the optimized flight path in a flight timeline, including all flight segments, airline flight numbers, travel times and layover times.

5. The computer implemented method of claim 1, further comprising displaying a graphical calendar showing departure date options, which include a sample flight price associated with one or more dates.

6. The computer implemented method of claim 1, further comprising providing a user an option to select the number of stops, maximum travel time, stopover duration, departure and arrival time, layover location, and airline.

7. The computer implemented method of claim 1, further comprising making each flight segment selectable by a user to display alternate flight pairs for each flight path.

8. The computer implemented method of claim 1, further comprising providing a user an option to select cheapest flight, best quality flight and quickest flight between the first location and the second location.

9. The computer implemented method of claim 1, further comprising,
providing a detailed timeline of the optimized flight path between the first location and the second location, the detailed timeline includes one or more segment flight paths;
making the flight destination of each segment flight path of the optimized flight path selectable by a user to display an alternate flight path to the segment flight path;
displaying information associated with a segment flight path including flight departure location, flight arrival location, flight departure time, flight arrival time, layover duration and number of stops;
displaying the information for one or more alternate flight paths including flight departure location, flight arrival location, flight departure time, flight arrival time, layover duration and number of stops; and
displaying an airline associated with the alternated flight path and a difference in price between the segment flight path and the alternate flight path.

10. The computer implemented method of claim 9, further comprising,
offering the user an option of choosing the alternate flight path; and
displaying an updated a detailed timeline of an optimized flight path between the first location and the second location including the alternate flight path.

11. The computer implemented method of claim 9, further comprising,
offering the user an option to extend the layover duration for any destination in a segment flight between the first location and the second location;
displaying the information for one or more alternate flight paths associated with the extended layover including flight departure location, flight arrival location, flight departure time, flight arrival time, layover duration and number of stops;
displaying an airline associated with the alternated flight path and a difference in price between the segment flight path and the alternate flight path;
offering the user an option of choosing the alternate flight path; and
displaying an updated a detailed timeline of an optimized flight path between the first location and the second location including the alternate flight path.

12. A computer implemented method for constructing an optimized flight path between a first location and a second location, said method comprising:
identifying a starting region associated with the first location;
determining if the first location is a hub airport in the starting region;
assigning the first location as a starting region airport hub if the first location is a hub airport in the starting region;
if the first location is not an airport hub in the starting region, constructing a flight path from the first location to the starting region airport hub in the starting region;
identifying a destination region associated with the second location;
determining if the second location is an airport hub in the destination region;
assigning the second location as a destination region airport hub if the second location is an airport hub in the destination region;
if the second location is not an airport hub in the destination region, constructing a flight path from the second location to the destination airport hub in the destination region;
constructing a flight path from the starting region airport hub in the starting region to the destination region airport hub in the destination region.

13. The computer implemented method of claim 12, further comprising,
constructing a flight timeline between the first location and the second location;
displaying the flight timeline;
making the first location in the flight timeline a user selectable hyperlink to offer the user an option of changing the flight information associated with the first location; and
making the second location in the flight timeline a user selectable hyperlink to offer the user an option of changing the flight information associated with the second location.

14. The computer implemented method of claim 12, further comprising displaying the details of the trip in a flight timeline, including all flight segments, airline flight numbers, travel times and layover times.

15. The computer implemented method of claim 12, further comprising displaying a graphical calendar showing departure date options, which include a sample flight price associated with one or more dates.

16. The computer implemented method of claim 12, further comprising,
providing a detailed timeline of an optimized flight path between the first location and the second location, said detailed timeline includes one or more segment flight paths;
making the flight destination of each segment flight path of the optimized flight path selectable by a user to display an alternate flight path to the segment flight path;
displaying information associated with a segment flight path including flight departure location, flight arrival location, flight departure time, flight arrival time, layover duration and number of stops;
displaying the information for one or more alternate flight paths including flight departure location, flight arrival location, flight departure time, flight arrival time, layover duration and number of stops; and
displaying an airline associated with the alternate flight path and a difference in price between the segment flight path and the alternate flight path.

17. The computer implemented method of claim 16, further comprising,
offering the user an option of choosing the alternate flight path; and
displaying an updated a detailed timeline of an optimized flight path between the first location and the second location including the alternate flight path.

18. The computer implemented method of claim 16, further comprising,
offering the user an option to extend the layover duration for any destination in a segment flight between the first location and the second location;
displaying the information for one or more alternate flight paths associated with the extended layover including flight departure location, flight arrival location, flight departure time, flight arrival time, layover duration and number of stops;
displaying an airline associated with the alternated flight path and a difference in price between the segment flight path and the alternate flight path;
offering the user an option of choosing the alternate flight path; and
displaying an updated a detailed timeline of an optimized flight path between the first location and the second location including the alternate flight path.

19. A computer implemented method for constructing an optimized flight path between a first location and a second location, said method comprising:
establishing a user account for booking travel by a user;
offering the user an option to select a first location associated with the flight;
offering the user an option to select a second location associated with the flight;
offering the user an option to select at least one date associated with the flight between the first location and the second location;
constructing a flight path from the first location to a hub in the starting region;
displaying a graphical calendar showing departure date options, which include a sample flight price associated with one or more dates;
identifying a destination region of the second location;
constructing a flight path from the second location to a hub in the destination region;
constructing a flight path from the hub in the starting region to the hub in the destination region;
constructing a flight timeline between the first location and the second location;
displaying the flight timeline;
making the first location in the flight timeline a user selectable hyperlink to offer the user an option of changing the flight information associated with the first location; and
making the second location in the flight timeline a user selectable hyperlink to offer the user an option of changing the flight information associated with the second location.

20. The computer implemented method of claim 19, further comprising,
offering the user an option to extend the layover duration for any destination in a segment flight between the first location and the second location;
displaying the information for one or more alternate flight paths associated with the extended layover including flight departure location, flight arrival location, flight departure time, flight arrival time, layover duration and number of stops;
displaying an airline associated with the alternated flight path and a difference in price between the segment flight path and the alternate flight path;
offering the user an option of choosing the alternate flight path; and
displaying an updated a detailed timeline of an optimized flight path between the first location and the second location including the alternate flight path.
